(19) United States
(12) Patent Application Publication
(10) Pub. No.: US 2002/0195830 A1
(43) Pub. Date: Dec. 26, 2002

(54) Apparatus for continuously adjusting the length of a slinging means designed to carry a load

(76) Inventors: Rolf Gotz, Ubach-Palenberg (DE); Willi Panhausen, Gangelt (DE)

Correspondence Address: PROSKAUER ROSE LLP, PATENT DEPARTMENT, 1585 BROADWAY, NEW YORK, NY, 10036, US

(21) Appl. No.: 10/043,019

(22) Filed: Jan. 8, 2002

(30) Foreign Application Priority Data
Jan. 10, 2001 (DE) 101 00 992.5-22

(51) Int. Cl. B66C 1/14

(52) U.S. Cl. 294/82.11

(57) ABSTRACT

The invention provides a device that is easy to use and inexpensive to manufacture, equipped with a device for adjusting the effective length (Lw) during the transport of a load (L1, L2) of a stop means (A) designed as a continuous loop, in particular a textile band folded or woven into a circular loop, or a continuous rope, which is equipped with a carrier part (2) that exhibits a projection (3, 4) at two opposed, spaced sides, around which a respective segment (A11, A12) of the stop means (A) can be slung.

The invention relates to an apparatus for continuously adjusting the length of a lifting sling designed to carry a load. Such lifting slings generally comprise flat woven textile slinging means which can be equipped with loops for attaching to the hook of a transport crane.

Lifting slings with loops but also in continuous form (belt slings) are sufficiently known from the old DIN 61360 or the new DIN EN 1492-1. They serve as slinging means with a working length precisely defined in each case. By equipping these lifting slings with suitable fittings such as D-clamps, these form suspension attachments which can be suspended from a crane hook. Additional forged coupling elements and hooks can form part of the known suspension attachment.

The known apparatus is only available in each case in a fixed length predefined by the manufacturer or user. In practice, the length of the lifting slings can only be suitably adapted to the particular transport problem to be overcome by using a high-strength slinging chain whose length can be adjusted using chain shorteners. This makes the handling of known apparatus complicated and limits its field of application.

The object of the invention is to improve the versatility of apparatus of the type explained previously.

This object is solved by an apparatus for continuously adjusting the length of a lifting sling designed to carry a load, which is provided with a U-shaped clamp having a bearing for a swivel axis constructed at each of its legs projecting from the ends of a central part of the clamp, a load-lifting element secured to the clamp to which the load can be attached, and a clamping element supported on the swivel axis, which has two side legs running parallel to one another at a distance, which each have their one free end coupled to the swivel axis, an end cross-piece formed at the other end of at least one side leg which covers the distance between the side legs, and a centre cross-piece arranged between the end cross-piece and the swivel axis. The swivel axis, the central part, the centre cross-piece, and the end cross-piece are preferably substantially axially parallel one to another.

An apparatus constructed according to the invention is intended to be attached to the unlooped end of a lifting sling. For this purpose the apparatus on the one hand has a U-shaped clamp to which the load to be carried is attached. On the other hand, the apparatus according to the invention is provided with a clamping element via which the coupling with the lifting sling,is made. This clamping element is designed so that the coupling between the lifting sling and the apparatus is made in a simple fashion and the required length of the lifting sling can be varied just as simply.

Thus, in the load-free state the apparatus according to the invention swivels into a threading-in position in which the lifting sling can be suitably located about the cross-pieces of the clamping element and the swivel axis without the action of forces impeding the threading process. Then, the apparatus is swivelled into its load-lifting position in which movement of the belt length is prevented by self-locking in the apparatus. At the same time, since the U-shaped clamp coupled to the load is flexibly coupled via a swivel axis to the clamping element forming the coupling to the lifting sling, this ensures that the forces to be absorbed during transport of the load are always introduced into the lifting sling in an optimal fashion. By bringing the apparatus into a position located between the threading-in position and the load-lifting position, this self-locking can be loosened to an extent that the length of the lifting tool can be adapted to the particular requirements without any problem.

The apparatus according to the invention is thus a connecting element which makes it possible to couple loads of various types and shapes to a single lifting sling in the sense of a modular system. The invention not only allows the length of the lifting sling to be varied arbitrarily but also allows attachment to the U-shaped clamp of a wide range of connecting elements and hooks which are best suited to the particular transport problem to be overcome.

The advantages of using an apparatus according to the invention especially emerge come to the fore when intricately shaped loads are to be transported on multi-strand suspension attachments. By coupling each individual strand of such a suspension attachment to the load via an apparatus according to the invention, the length of each strand can be adapted to the geometry and the centre of gravity of the load without any problem so that the safest possible transport can be ensured even for loads having a non-uniform geometry.

The forming of the U-shaped clamp can be simplified by constructing the elements required to attach the load-lifting element at the central part of the U-shaped clamp. Naturally, it is however just as feasible to form suitable elements at the legs of the relevant clamp. With reference to an optimum introduction of the forces to be absorbed into the clamp and the lifting sling coupled to the clamp during transport, it is favourable if the load-lifting element is flexibly supported on the U-shaped clamp.

An embodiment of the apparatus according to the invention which substantially facilitates threading in the lifting sling is characterised by the fact that the first side leg carrying the end cross-piece is longer than the second side leg of the clamping element. In this way between the end of the end cross-piece and the free end of the second side leg there is a free space through which the lifting sling can be pushed. With reference to the safety of the self-locking under load it is favourable if the free end of the end cross-piece is arranged facing the end of the second side leg assigned to it and at some distance from this end. This ensures that the lifting sling is supported on the end cross-piece over its entire width. The safety of guiding the belt in the clamping element is further improved by the end cross-piece having at its free end an extension oriented towards the end of the second leg. This extension reliably prevents the belt from sliding out of the clamping element in the load-free state or during adjustment of the length. The same purpose is served if the second side leg has its end assigned to the end cross-piece projecting above the position at which it is connected to the centre cross-piece. The section projecting above the end cross-piece prevents the belt from slipping from the centre cross-piece.

The components of an apparatus according to the invention can be manufactured particularly economically by forging.

Further advantageous embodiments of the invention are given in the dependent claims and are explained in greater detail in connection with the example of embodiment explained with reference to the drawings, where

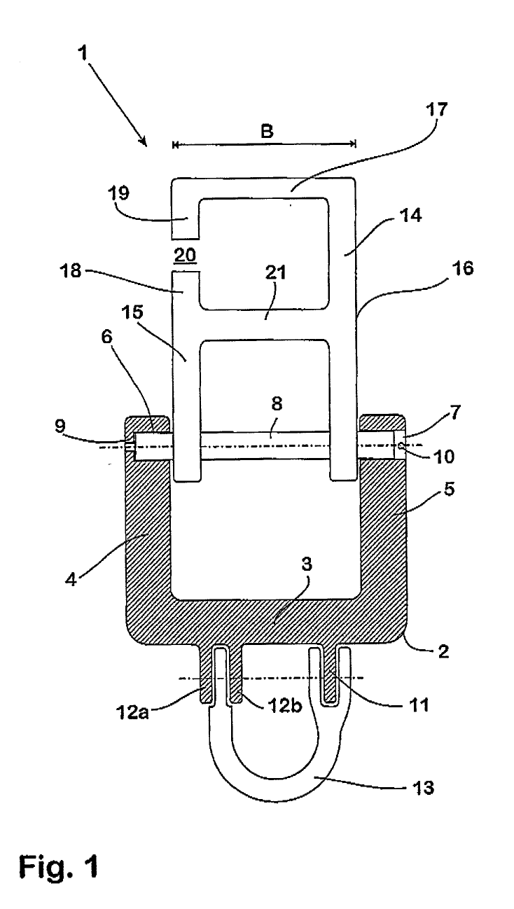

FIG. 1 is a front view of an apparatus for adjusting the length of a lifting sling carrying a load,

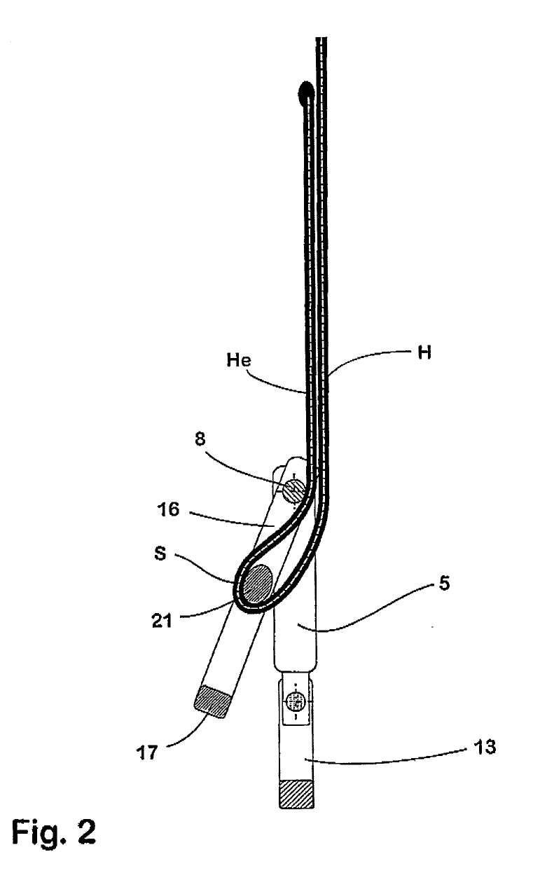

FIGS. 2 to 4 are side views of a suspension attachment constructed from a lifting sling and an apparatus according to FIG. 1 in various operating positions.

The apparatus 1 is intended for adjusting the length of a lifting sling H and for coupling a load F to the lifting sling H. Said apparatus has a U-shaped clamp 2 forged from a metal material, which has a web-shaped central part 3. Legs 4, 5 are formed on each end of the central part 3 at right angles therefrom.

The legs 4, 5 have the same lengths. At their free ends a bearing 6, 7 is constructed for a swivel axis 8 running substantially parallel to the central part 3. The bearing 6 assigned to the one leg 4 has a stop 9 at its outer side facing away from the leg 5 whereas the bearing 7 of the other leg 5 is constructed as a through opening. For assembly the swivel axis 6 is accordingly pushed through this bearing 7 until its one end locates in the opposite bearing 6. A safety element 10, constructed as a splint, is then pushed into a side opening of the bearing 7 provided for this purpose so that the swivel axis 8 is secured against falling out from the bearings 6, 7 as a result of an excessive axial displacement.

On its side facing the swivel axis 8 shoulders 11, 12a, 12b are formed on the central part 3 on which, for example, an arc-shaped load-lifting element 13 designed to accommodate the load F can be flexibly supported. The shoulders 12a, 12b are arranged so close together that one end of the load-lifting element 13 is held in them such that it is secure against displacement in the axial direction. For the same purpose the end of the load-lifting element 13 assigned to the shoulder 11 surrounds this in a fork shape. Depending on the particular transport problem to be overcome, hooks or other load-lifting elements not shown can be attached to the shoulders 11, 12a, 12b.

The free ends of the side legs 14, 15 of a clamping element 16 forged from metal material are supported with the swivel axis 8 using bearings not shown in detail. The width B of this clamping element 16 is dimensioned such that the side legs 14, 15 extend into the space defined by the legs 4, 5 of the U-shaped clamp 2.

The side legs 14, 15 essentially extend parallel to one another and at right angles to the swivel axis 8. The one side leg 14 is approximately a third longer than the second side leg 15. At its free end the first leg 14 has an arm-shaped end cross-piece 17 positioned at right angles therefrom and extending axially parallel to the swivel axis 8 over the width B of the clamping element 16. At its free end positioned opposite the free end section 18 of the second side leg 15 the end cross-piece 17 has an extension 19 oriented in the direction of the second side leg so that a guide slot 20 is formed between the end of the extension 19 and the end section 18.

A centre cross-piece 21 extends between the side legs 14, 15 approximately at the centre between the swivel axis 8 and the end cross-piece 17 and substantially axially parallel thereto. The length of the second side leg 15 is selected so that its end section 18 projects freely over a sufficient length above the junction point between the side leg 15 and the centre cross-piece 21.

In order to thread in the unlooped end section He of the lifting sling H suspended vertically downwards from a crane not shown in the apparatus 1, the clamping element 16 is swivelled anticlockwise about the swivel axis 8 in the direction of the load-lifting element 13 until an acute angle of approximately 20° is enclosed between the clamp 2 and the clamping element 16. The end section He of the lifting sling H is then placed around the centre cross-piece 21 from the side facing away from the clamping element 16 and guided back to that side of the swivel axis 8 assigned to the section of the lifting sling H leading to the crane. In this way, the end section He is located there between the lifting sling H and the swivel axis 8 and a loop S is formed around the centre cross-piece 21 (FIG. 2).

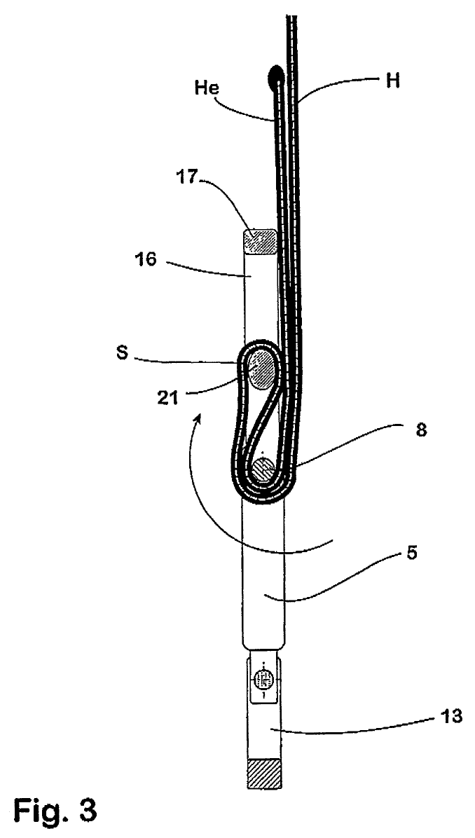

The clamping element 16 is then swivelled back in the clockwise direction into its initial position in which it is aligned essentially in line with the clamp 2. With this swivelling movement the loop S is drawn upwards so that the swivel axis 8 is surrounded around more than 180° by the end section He and the section of the lifting sling H leading to the crane, which lies on it. Three layers of the lifting sling, namely the loop S, the end section He and the section of the lifting sling H leading to the crane lie simultaneously on the side of the centre cross-piece 21 assigned to the lifting sling H (FIG. 3),

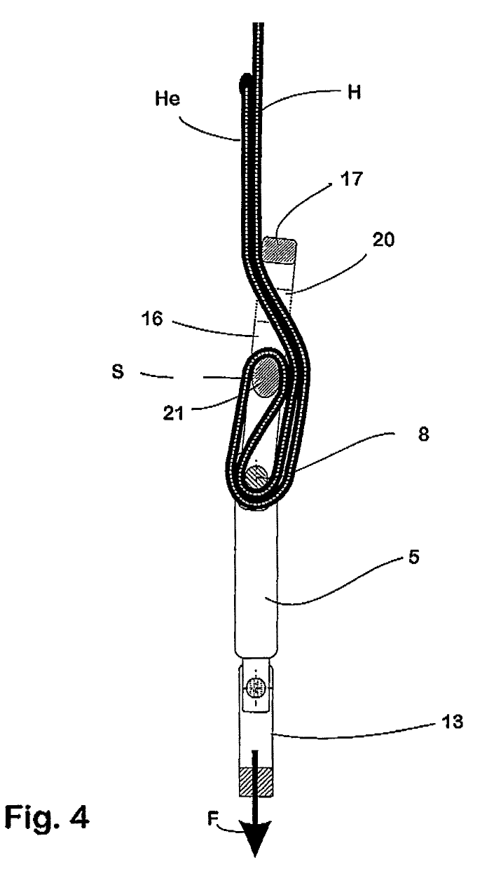

Finally the end section He and the section of the lifting sling H leading to the crane are threaded through the guide slot 20 so that the side facing away from the end section He of the section of the lifting sling H leading to the crane lies on the end cross-piece 17 and when the load F is applied, this results in self-locking of the sling in the apparatus 1 (FIG. 4).

By swivelling the clamping element 16 anticlockwise again, the self-locking can be released for the length of the lifting sling H to be adapted to the particular transport problem.

For coupling with the crane the lifting sling H can have a simple loop, not shown here, constructed by sewing. Likewise, a D-shaped clamp not shown here can be connected to the lifting sling H via a suitable loop. Likewise several lifting slings H can be attached jointly via a single ring to a crane or another transport, lifting or holding apparatus.

A suspension attachment for transporting goods having a non-uniform external shape can be equipped with several lifting slings H arranged along the goods to be transported. By using an apparatus 1 it is then possible to adapt their length individually to the outside diameter at the respective point of attachment.

REFERENCE SYMBOLS

| F | Load |
|---|---|
| B | Width of clamping element 16 |
| H | Lifting sling |
| He | End section He of lifting sling H |
| 1 | Apparatus for adjusting the length of a |
| | lifting sling H |
| 2 | U-shaped clamp |
| 3 | Central part of U-shaped clamp 2 |
| 4, 5 | Legs of U-shaped clamp 2 |
| 6, 7 | Bearings |
| 8 | Swivel axis |
| 9 | Stop |
| 10 | Safety element |
| 11, 12a, 12b | Shoulders |
| 13 | Load-lifting element |
| 14, 15 | Side legs |
| 16 | Clamping element |
| 17 | End cross-piece |
| 18 | End section of side leg 15 |
| 19 | Extension |
| 20 | Guide slot |
| 21 | Centre cross-piece |

1. An apparatus for continuously adjusting the length of a lifting sling (H) designed to carry a load (F)
with a U-shaped clamp (2) having a bearing (6, 7) for a swivel axis (a) constructed at each of its legs (4, 5) projecting from the ends of a central part (3) of the clamp (2),
with a load-lifting element (13) attached to the clamp (2) to which the load (F) can be attached and
with a clamping element (16) supported on the swivel axis (8) which
has two side legs (14, 15) some distance from one another, which each have their one free end coupled to the swivel axis (8),
an end cross-piece (17) formed at the other end of at least one of the side legs (14), which covers the distance between the side legs (14, 15), and
a centre cross-piece (21) located between the end cross-piece (17) and the swivel axis (8).

2. The apparatus according to claim 1, characterised in that the swivel axis (8), the central part (3), the centre cross-piece (21) and the end cross-piece (17) extend substantially axially parallel one to the other.

3. The apparatus according to one of the preceding claims, characterised in that the load-lifting element (13) is attached to the central part (3) of the U-shaped clamp (2).

4. The apparatus according to one of the preceding claims, characterised in that the load-lifting element (13) is supported flexibly on the U-shaped clamp (2).

5. The apparatus according to one of the preceding claims, characterised in that the first side leg (14) having the end cross-piece (17) is longer than the second side leg (15) of the clamping element (16).

6. The apparatus according to claim 5, characterised in that the free end of the end cross-piece (17) is arranged opposite the end of the second side leg (15) assigned to it and at some distance from this.

7. The apparatus according to claim 5 or 6, characterised in that the end cross-piece (17) has an extension (19) oriented in the direction of the end of the second leg (15) at its free end.

8. The apparatus according to one of claims 5 to 7, characterised in that the end (18) of the second, side leg (15) assigned to the end cross-piece (17) projects above the point at which it is joined to the centre cross-piece (21).

9. The apparatus according to one of the preceding claims, characterised in that the swivel axis (8) is protected against any axial movement going beyond a tolerance range by means of a safety element (10).

10. The apparatus according to one of the preceding claims, characterised in that the width (B) of the clamping element (16) is shorter than the distance between the legs (4, 5) of the U-shaped clamp (2).

11. The apparatus according to one of the preceding claims, characterised in that at least the U-shaped clamp (2) and the clamping element (16) are manufactured by forging.
